(19) United States
(12) Patent Application Publication
(10) Pub. No.: US 2007/0177572 A1
(43) Pub. Date: Aug. 2, 2007

(54) Method and system for reporting synchronization status in a network of RF receivers

(76) Inventor: Leon K. Werenka, Mukilteo, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/344,880

(22) Filed: Jan. 31, 2006

(51) Int. Cl. H04J 3/06

(52) U.S. Cl. 370/350; 370/509

(57) ABSTRACT

Timing information comprised of a network-based time synchronization protocol is exchanged over the network in order to synchronize a receiver clock in each RF receiver to a common network time. Each RF receiver generates a status parameter characterizing the synchronization of its receiver clock to the common network time when the receiver transmits a message over the network. A central processing device and each RF receiver that receives a message analyzes the status parameter to determine the synchronization status of the transmitting RF receiver.

### BACKGROUND

Networks of RF receivers are used in a variety of applications and systems. Synchronizing each receiver to a common time enables new untried measurements to be performed and typically results in more effective and efficient operations, control, and measurement functions in the receivers and the network. For example, time synchronization improves receiver operations when the receivers perform a task at the same time or geolocate an RF transmitter.

FIG. 1 is a timing diagram in accordance with the prior art. Points 100, 102, 104, 106 represent a common synchronization time 108 for four receivers. In practice, however, one or more receivers may not synchronize precisely to common time 108. For example, as illustrated in FIG. 1, one receiver synchronizes to a time represented by point 110 while the other three receivers synchronize to common time 108. The time difference between common synchronization time 108 and time 110 can cause problems for the one receiver when acquiring or processing RF data. For example, the time difference can result in an incorrect or indefinite geolocation determination or an inability to perform a given task at the proper time.

### SUMMARY

In accordance with the invention, a method and system for reporting synchronization status in a network of RF receivers are provided. Timing information comprised of a network-based time synchronization protocol is exchanged over the network in order to synchronize a receiver clock in each RF receiver to a common network time. Each RF receiver generates a status parameter characterizing the synchronization of its receiver clock to the common network time when the receiver transmits a message over the network. The message may include, for example, RF data, a timestamp associated with the RF data, and a status parameter. A central processing device or each RF receiver that receives a message analyzes the status parameter to determine the synchronization status of transmitting RF receiver.

### BRIEF DESCRIPTION OF THE DRAWINGS

FIG. 1 is a timing diagram in accordance with the prior art;

FIG. 2 is a diagrammatic illustration of a network of RF receivers in an embodiment in accordance with the invention;

FIG. 3 is a block diagram of an RF receiver for use in a network of RF receivers in an embodiment in accordance with the invention;

FIG. 4 is a flowchart of a method for reporting synchronization status in a network of RF receivers in an embodiment in accordance with the invention;

FIG. 5 is an illustration of a message transmitted by an RF receiver in an embodiment in accordance with the invention; and

FIG. 6 is a flowchart of a method for receiving a message in a network of RF receivers in an embodiment in accordance with the invention.

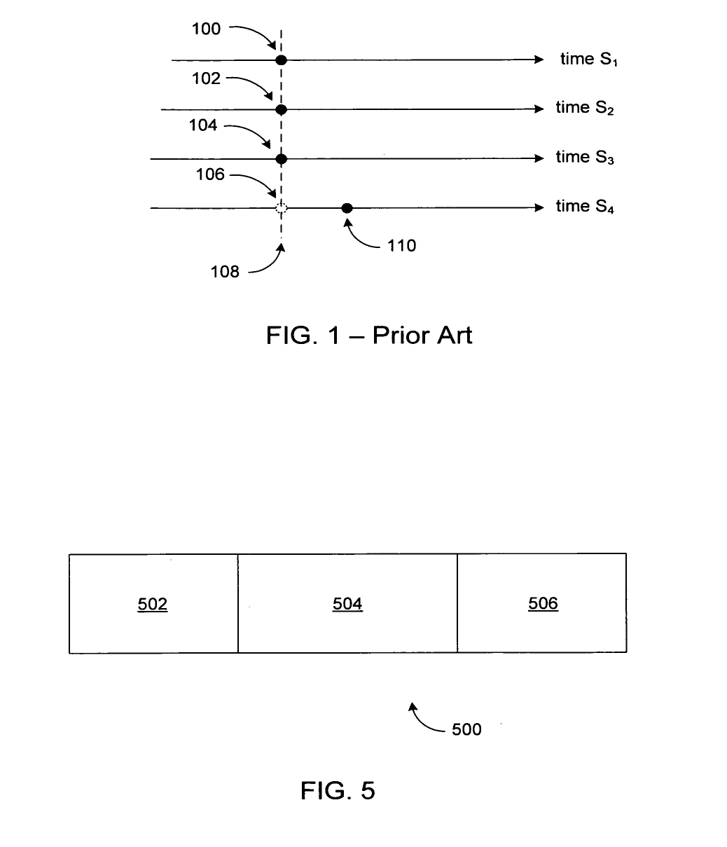

### DETAILED DESCRIPTION

The following description is presented to enable embodiments in accordance with the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown, but is to be accorded the widest scope consistent with the appended claims and with the principles and features described herein.

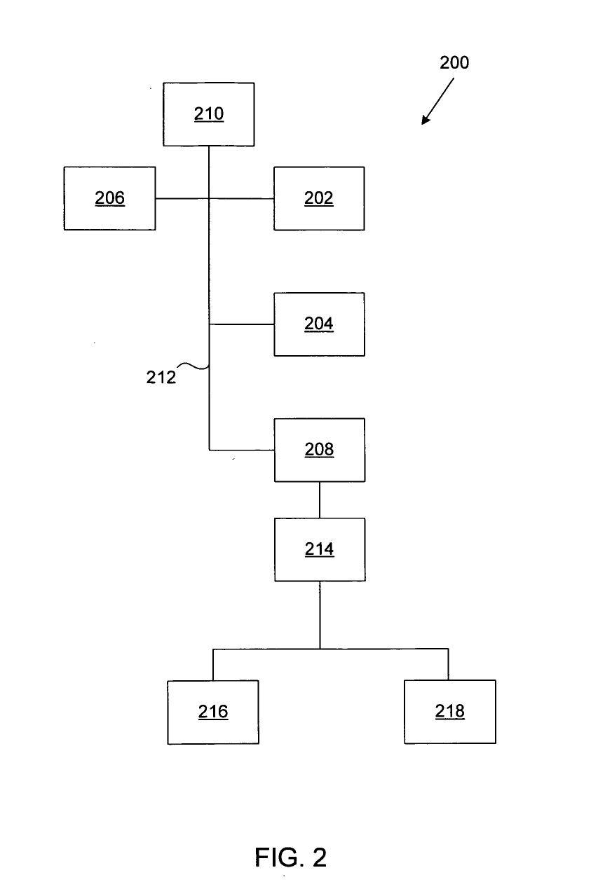

With reference to the figures and in particular with reference to FIG. 2, there is shown a diagrammatic illustration of a network of RF receivers in an embodiment in accordance with the invention. A network of RF receivers is arranged in any given topology in other embodiments in accordance with the invention. Network 200 includes RF receivers 202, 204, central processing device 206, and router 208 each connected to common network clock 210 through network connection 212.

Network connection 212 is implemented as a wired connection in an embodiment in accordance with the invention. For example, network 200 is a wired local area network (LAN) in an embodiment in accordance with the invention. In other embodiments in accordance with the invention, network connection 212 is implemented as a wireless connection, such as a wireless local area network (WLAN), or as a combination of both wired and wireless connections.

Repeater 214 is connected to router 208 and RF receivers 216, 218. Each RF receiver 202, 204, 216, 218 may be implemented as a discrete component or integrated within another device. Central processing device 206 controls RF receivers 202, 204, 216, 218 and is implemented as a discrete processing device, such as a computer, in an embodiment in accordance with the invention. In another embodiment in accordance with the invention, central processing device 206 is integrated within an RF receiver in network 200.

RF receivers 202, 204, 216, 218 use network 200 for data transmission and processing in an embodiment in accordance with the invention. For example, RF receiver 202 may transmit or receive data from RF receiver 218 in network 200. RF receivers 202, 204, 216, 218 transmit data to central processing device 206 for data processing and analysis in an embodiment in accordance with the invention.

Central processing device 206 and RF receivers 202, 204, 216, 218 also exchange timing information that is used to synchronize RF receivers 202, 204, 216, 218 to a common time defined by common network clock 210. Common network clock 210 is integrated within central processing device 206 or within an RF receiver in network 200 in an embodiment in accordance with the invention.

Network 200 uses the Institute of Electrical and Electronic Engineers (IEEE) 1588 Standard to synchronize RF receivers 202, 204, 216, 218 to a common network time in an embodiment in accordance with the invention. Other embodiments in accordance with the invention may implement different network-based time synchronization protocols, such as, for example, NTP. Moreover, the network devices that add delay, such as router 208 and repeater 214, may need symmetrical transmission and reception delays in other embodiments in accordance with the invention. In some of these embodiments, the delays may be compensated for in the RF system calibrations when the mean of the asymmetrical delays is stationary over a time interval.

The required accuracy in synchronizing RF receivers 202, 204, 216, 218 depends on the application. Precise timing accuracy is required in some applications, such as in geolocation applications. For signal detection, the timing accuracy is determined by the amount of memory in each device and the network latency. In other embodiments in accordance with the invention, other types of devices or systems may be used for the common network clock, including, but not limited to, other networking timing protocols, such as NTP, global positioning systems (GPS), high stability internal clocks such as atomic clocks, or any other clock with long-term stability compatible with the application.

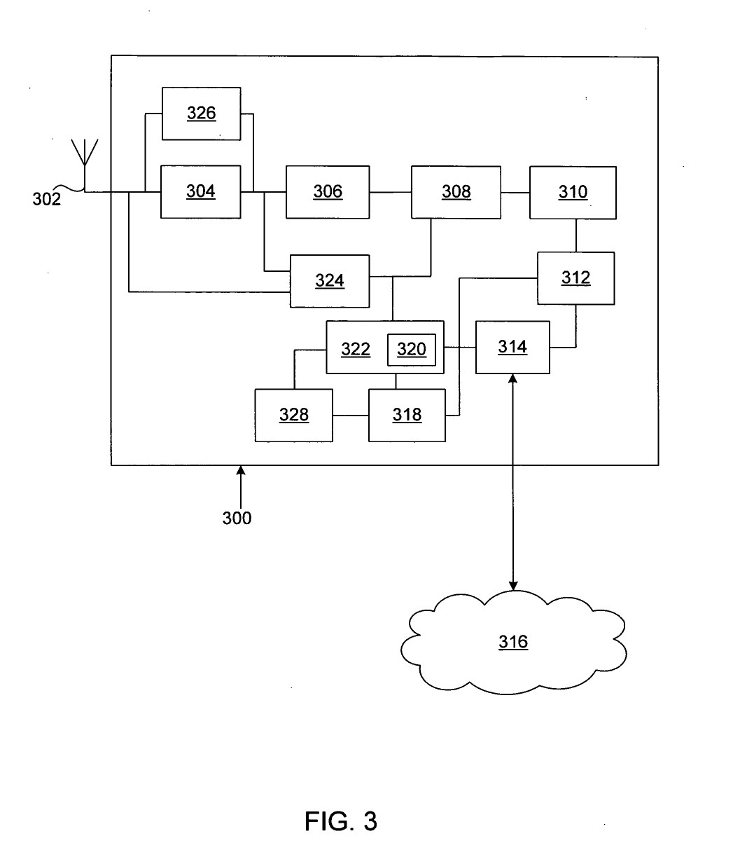

FIG. 3 is a block diagram of an RF receiver that can be used in network 200 in an embodiment in accordance with the invention. RF receiver 300 includes antenna 302 that receives RF data or signals. Although only one antenna is shown in FIG. 3, RF receiver 300 may include multiple antennas in other embodiments in accordance with the invention.

Downconverter 304 receives RF data from antenna 302 and converts the RF data to a particular frequency spectrum. The RF data are then transmitted to digitizer 306, which converts the analog RF data to digital data. The digitized data are input into digital intermediate frequency (IF) 308. Digital IF 308 is a variable digital IF in an embodiment in accordance with the invention that variably limits the signal bandwidth and sample rate. Digital IF 308 also provides additional spectral isolation and enhancement of the receiver frequency and time-stamps the RF data that is subsequently stored in memory 310.

Downconverter 304 has a bandwidth that is equal to or greater than the bandwidth of digital IF 308 in an embodiment in accordance with the invention. Downconverter 304 has narrower bandwidths, fixed or selectable, that limit the bandwidth to improve performance by eliminating or reducing the levels of unwanted adjacent signals in other embodiments in accordance with the invention. As the bandwidth of digital IF 308 is adjusted to match the signal to be detected, the output sample rate of digital IF 308 is also adjusted to a rate that is sufficient to preserve information while at the same time maximizing memory utilization. Beyond a certain sample rate, no additional information is retained, memory is wasted, and signals can be observed for less time. The combination of downconverter 304 and digital IF 308 provide the flexibility to deal with a wide variety of signal types. When dealing with a fixed set of known signal formats, downconverter 304 and digital IF 308 may provide less flexibility in other embodiments in accordance with the invention.

The time interval between samples at the output of digital IF 308 may be longer than the accuracy required for a given application. For example, a signal with a 1 kHz bandwidth can be perfectly represented by complex samples (real and imaginary, or I and Q), taken at a 1 kHz rate or at 1 millisecond intervals. For geolocation, the accuracy required may be 50 nanoseconds or better. The data output from digital IF 308 and input into memory 310 is time-stamped with sufficient precision and accuracy for the application, independent of the sample rate going into, or coming out of digital IF 308. In another embodiment in accordance with the invention, a time is associated with a portion of the samples. For example, a time is associated with only one sample when the samples are evenly spaced and the sample rate is known.

Although only one receiver channel is shown in FIG. 3, RF receiver 300 may include multiple receiver channels in other embodiments in accordance with the invention. Data from the multiple receiver channels may be combined in receiver 300 before it is transmitted to the central processing device. For example, data from the multiple receiver channels are combined to perform beam steering in an embodiment in accordance with the invention. Alternatively, data from the receiver channels are not combined but transmitted to the central processing device for processing in another embodiment in accordance with the invention.

Digital signal processor 312 reads the buffered data from memory 310 and processes the digital data. Examples of data processing that may be performed by digital signal processor 312 include, but are not limited to, signal compression, demodulation, feature extraction, and data reduction. Network controller 314 transmits the data to another device in network 316. The other device may be another RF receiver or a central processing device. Device controller 318 formats the data for transmission over a network, initiates or regulates data acquisition and transfer, and provides other controller functions.

Network controller 314 also receives timing information from network 316 that is used to synchronize receiver clock 320 in time controller 322 to a common time in an embodiment in accordance with the invention. The common time is defined by a common network clock (e.g., 210 in FIG. 2). In other embodiments in accordance with the invention, receiver clock 320 acts as a common network clock and network controller 314 exchanges timing information with the other RF receivers in network 316 to synchronize the RF receivers to the common time as defined by receiver clock 320.

Time controller 322 distributes timing information to the other components in RF receiver 300. Time controller 322 provides data to digital IF 308 to allow digital IF 308 to timestamp data or events with a time of day. Time controller 322 may also provide accurate timing information to digitizer 306 and serves as a frequency reference for downconverter 304, which improves the quality of the signal and provides long term timing stability. Time controller 322 may also improve short term timing stability by using high-quality oscillators in an embodiment in accordance with the invention. In another embodiment in accordance with the invention, time controller 322 serves as a temporary timing service when the network timing services are degraded or unavailable.

In other embodiments in accordance with the invention, time controller 322 provides data to allow digital IF 308 to timestamp data or events with a time of day and provides a frequency reference to digitizer 306. In this embodiment, the samples from one RF receiver (e.g., receiver 202) have no particular alignment with the samples from another RF receiver (e.g., receiver 204). This random phasing of the sample clocks is compensated for in the signal processing algorithms in central processing device 206 (see FIG. 2). This is done in the time domain, for example, by noting the differences in the timestamps and re-sampling the signal from one receiver so that the samples are time-aligned with the samples from the other receiver. Other methods may also be used, depending on the processing. For example, the cross-spectrum between the two signals may be computed and multiplied by a phase ramp, the slope of which corresponds to the time-stamp difference.

Trigger circuit 324 triggers action or the cessation of action within RF receiver 300. By way of example only, trigger circuit 324 can trigger data acquisition or the cessation of data acquisition within RF receiver 300. Memory 310 may therefore contain all samples leading up to the trigger event, all samples occurring after the trigger event, or combination of samples from before and after the trigger event. Trigger circuit 324 is implemented as a time of day trigger in an embodiment in accordance with the invention. Trigger circuit 324 receives time of day information from time controller 322.

In another embodiment in accordance with the invention, trigger circuit 324 is implemented as an event trigger that triggers when a trigger criterion, or criteria, is met. For example, in one embodiment in accordance with the invention, trigger circuit 324 triggers when an amplitude or frequency of the RF data received from antenna 302 meets or exceeds a predetermined value, or when a trigger message is received.

And in yet another embodiment in accordance with the invention, characteristics of the RF data output from downconverter 304 or in digital IF 308 can trigger circuit 324. And in yet another embodiment in accordance with the invention, the trigger criterion or criteria may be an event or input that originates outside of receiver 300, such as, for example, a trigger input, lighting detector, or door alarm.

Calibration circuit 326 is used to characterize the signal paths in RF receiver 300. For example, calibration circuit 326 injects signals into either the RF signal received from antenna 302 or the IF signal output from downconverter 304 to compensate for group delay and amplitude errors. Control circuit 328 generates a status parameter characterizing the synchronization of receiver clock 320 to the common network clock (e.g. 210 in FIG. 2) in an embodiment in accordance with the invention. The status parameter is included in a message containing RF data and is used to indicate one or more possible synchronization states in an embodiment in accordance with the invention. For example, only one of two possible status parameters is included with the RF data in an embodiment in accordance with the invention. The two possible status parameters indicate a “synchronized” state and a “not synchronized” state.

In another embodiment in accordance with the invention, one of five possible status parameters is included in a message. The five possible status parameters are used to indicate an “initializing” state where receiver 300 is in the process of powering up, a “not synchronized” state, a “phase locked” state, a “locking” state where time controller 322 is in the process of reaching the “phase locked” state, and a “no time synchronization data” state. The “no time synchronization data” state is used, for example, when an RF receiver is not receiving timing information from the network. In other embodiments in accordance with the invention, the status parameter may include any number of possible states.

A quality parameter is used as a status parameter in another embodiment in accordance with the invention. And in yet another embodiment in accordance with the invention, a status parameter includes both a status of the time synchronization and a quality parameter. The quality parameter is a numerical value that quantifies the accuracy of the time synchronization in an embodiment in accordance with the invention. In another embodiment in accordance with the invention, the quality parameter is a figure of merit that characterizes the stability of the time synchronization within the receiver's operating environment. For example, the quality parameter may include the effects of temperature on the crystal oscillators of the receiver clock. Accurate timing depends on a stable frequency from these crystals and temperature variations impact this stability. The quality parameter may represent the variance of the estimated clock error over time as computed by control circuit 328.

The quality parameter is derived from other sources in other embodiments in accordance with the invention. For example, the quality parameter may be derived from the common network clock, other networking time protocols, such as NTP, GPS, atomic clock, or any other clock with long term stability compatible with the application.

Control circuit 328 also analyzes the status parameter included in the messages received by RF receiver 300 in an embodiment in accordance with the invention. The status parameter may be analyzed for a variety of purposes. For example, the status parameter may be analyzed to determine the usability of the RF data included in the message. As another example, the status parameter may be analyzed to weigh or scale the applicability of the RF data included in the message. And in yet another example, the status parameter may be analyzed to determine the synchronization status of the device transmitting the message.

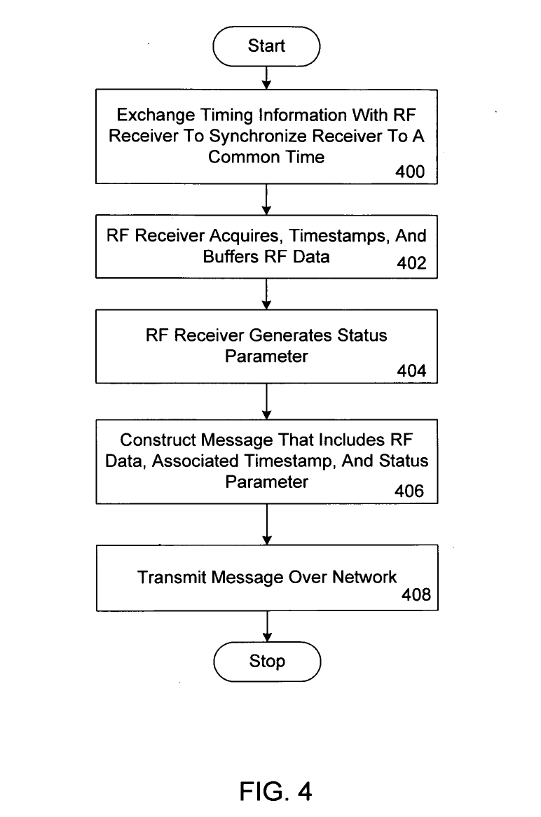

Referring to FIG. 4, there is shown a flowchart of a method for reporting synchronization status in a network of RF receivers in an embodiment in accordance with the invention. Although the method shown in FIG. 4 is described in conjunction with a single RF receiver in the network, the method may be performed concurrently by some or all of the RF receivers in the network. Initially timing information is exchanged with an RF receiver in the network to allow the RF receiver to synchronize to a common network time, as shown in block 400.

Next, at block 402, the RF receiver acquires, timestamps, and buffers RF data. The timestamps indicate the time of day when the RF data is acquired. The RF receiver then generates a status parameter that characterizes the status of the synchronization of its receiver clock to the common network time, as shown in block 404. The RF receiver may determine the status of the time synchronization using one of several techniques. For example, in one embodiment in accordance with the invention, the RF receiver determines the status by comparing the exchanged network-based time synchronization protocol messages with the time output by its receiver clock. In another embodiment in accordance with the invention, the RF receiver uses a time source outside the network, such as, for example, a GPS system, to determine the status of the time synchronization. And in yet another embodiment in accordance with the invention, the RF receiver uses the adjustments required to synchronize its receiver clock to the network clock (e.g., variance) to determine the status of the time synchronization.

Next, at block 406, the receiver constructs a message that includes RF data, a timestamp associated with the RF data, and a status parameter (block 406). The status parameter characterizes the status of the synchronization process at the time the RF data was acquired in an embodiment in accordance with the invention. The RF receiver then transmits the message over the network, as shown in block 408. The message is transmitted to a central processing device in an embodiment in accordance with the invention. In another embodiment in accordance with the invention, the message is transmitted to one or more RF receivers in the network.

FIG. 5 is an illustration of a message transmitted by an RF receiver in an embodiment in accordance with the invention. Message 500 includes RF data section 502, timestamp section 504, and status parameter section 506. RF data section 502 includes RF data received by the receiver. Timestamp section 504 includes a time of day as to when the RF data is received by the receiver. And status parameter section 506 includes a status of the synchronization of a receiver clock to the common network time, a quality parameter, or both a synchronization status and quality parameter in embodiments in accordance with the invention. Other embodiments in accordance with the invention may include additional sections, different sections, or fewer sections in a message. By way of example only, a message may include information identifying the RF receiver transmitting the message.

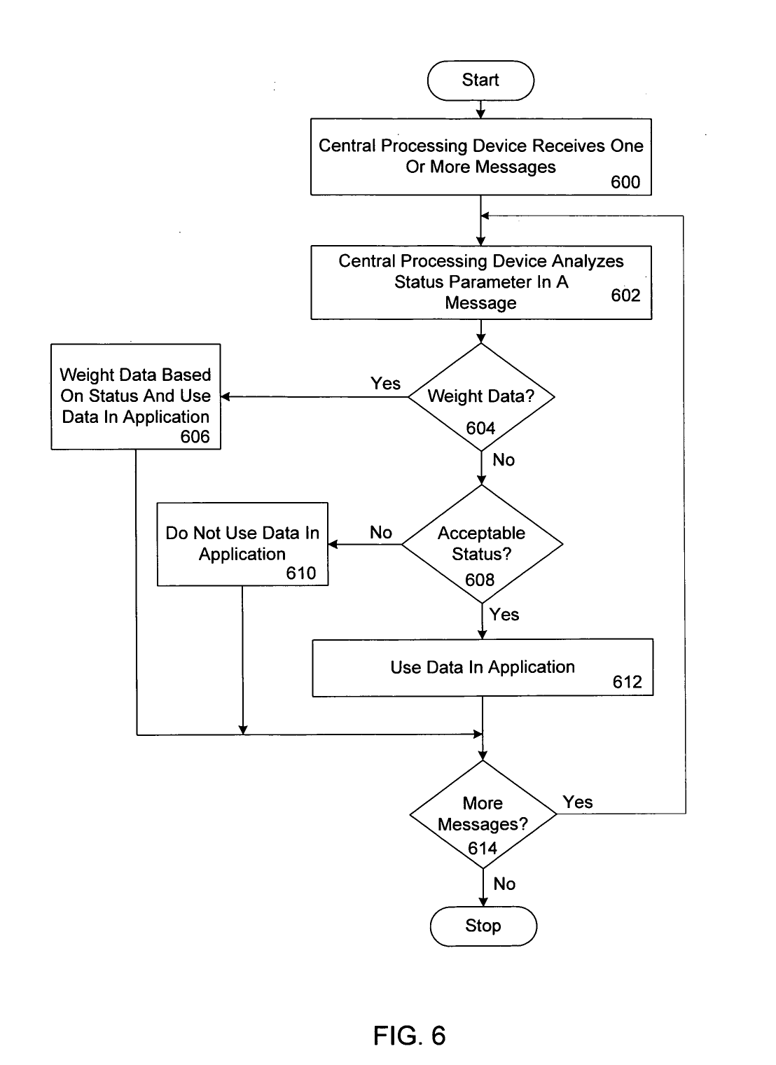

Referring to FIG. 6, there is shown a flowchart of a method for receiving a message in a network of RF receivers in an embodiment in accordance with the invention. Initially a central processing device receives one or more messages from an RF receiver or receivers in the network, as shown in block 600. In other embodiments in accordance with the invention, the message may be received by one or more RF receivers in the network or by a combination of the central processing device and one or more RF receivers.

In the embodiment shown in FIG. 6, the message includes RF data section 502, timestamp section 504, and status parameter section 506 from FIG. 5. The central processing device analyzes the status parameter in the message at block 602. The central processing device or another RF receiver determines the usability of the RF data based on the contents of the status parameter in this embodiment in accordance with the invention. As discussed earlier, the central processing device or one or more RF receivers may analyze the status parameter for purposes other than, or in addition to, the usability of the RF data. A determination is made at block 604 as to whether a weight is to be applied to the RF data. By way of example only, a status parameter may include a weighing factor that is applied by the RF receiver to the RF data included in the message. The weighing factor may be based, for example, on the receiver clock variance for the transmitting RF receiver. The variance may be an actual measured variance or the variances averaged over time. The weighing factor may be determined by the magnitude of the variance.

If a weight is to be applied to the RF data, the method passes to block 606 where the weighing factor is applied to the RF data and the data used in a particular application. One example of an application is geolocation, where the messages received from multiple RF receivers are used to locate an RF transmitter. If a weighing factor is not to be applied to the RF data, the process continues at block 608 where a determination is made as to whether the status parameter indicates an acceptable status. If not, the method passes to block 610 where the RF data is not used in a particular application. For example, when the status parameter includes a status of the time synchronization and the status parameter indicates a “not synchronized” status, the central processing device may not include the RF data in an application where the accuracy of the timestamp is important.

If, however, the status parameter indicates an acceptable status, the central processing device includes the RF data in the application, as shown in block 612. For example, when the status parameter includes a quality parameter that characterizes an acceptable stability of the time synchronization, the central processing device includes the RF data in the application. A determination is then made at block 614 as to whether there are other messages to process. If so, the method returns to block 602 and repeats until all of the messages have been processed.

1. An RF receiver for use in a network of RF receivers, comprising:
a receiver clock;
a network controller for exchanging timing information comprised of a network-based time synchronization protocol in order to synchronize the receiver clock to a common time; and
a control circuit for generating a status parameter characterizing the synchronization of the receiver clock to the common time.

2. The RF receiver of claim 1, wherein the control circuit also analyzes a status parameter received by the network controller characterizing the time synchronization of another RF receiver in the network of RF receivers to the common time.

3. The RF receiver of claim 1, further comprising a time controller for synchronizing the receiver clock to the common time based on the exchanged timing information.

4. The RF receiver of claim 1, further comprising a device controller for formatting a message for transmission over the network, wherein the message comprises the status parameter.

5. The RF receiver of claim 1, wherein the status parameter comprises at least one of a status of the synchronization of the receiver clock to the common time, a quality parameter characterizing a stability of the synchronization of the receiver clock to the common time, and a quality parameter comprised of a numerical value that quantifies the accuracy of the synchronization of the receiver clock to the common time.

6. A network, comprising:
a central processing device;
a common network clock for defining a common network time; and
a plurality of RF receivers each connected to the central processing device through a network connection, wherein each RF receiver includes a network controller for exchanging timing information comprised of a network-based time synchronization protocol with the central processing device to synchronize its receiver clock to the common network time and a control circuit for generating a status characterizing the synchronization of the receiver clock to the common network time.

7. The network of claim 6, wherein the control circuit also analyzes a status parameter received by the network controller characterizing the time synchronization of another RF receiver in the network of RF receivers to the common time.

8. The network of claim 6, wherein the common network clock is integrated within one RF receiver in the plurality of RF receivers.

9. The network of claim 6, wherein the common network clock is integrated within the central processing device.

10. The network of claim 6, wherein the central processing device comprises a discrete computing device.

11. The network of claim 6, wherein the central processing device is integrated within one RF receiver in the plurality of RF receivers.

12. In a network comprised of a plurality of RF receivers, a central processing device, and a common network clock defining a common network time, a method for reporting a synchronization status of a receiver clock in an RF receiver to the common network time, the method comprising:
acquiring RF data;
timestamping the RF data indicating a time of day when the RF data is acquired; and
generating a status parameter characterizing the synchronization of the receiver clock to the common network time.

13. The method of claim 12, further comprising:
constructing a message that includes acquired RF data, a timestamp associated with the RF data, and the status parameter; and
transmitting the message over the network.

14. The method of claim 13, wherein transmitting the message over the network comprises transmitting the message to the central processing device.

15. The method of claim 12, further comprising exchanging timing information comprised of a network-based time synchronization protocol over the network in order to synchronize the receiver clock to the common network time.

16. In a network comprised of a plurality of RF receivers, a central processing device, and a common network clock defining a common network time, a method for reporting a synchronization status of a receiver clock in an RF receiver to the common network time, the method comprising:
receiving a message comprising a status parameter characterizing a status of synchronizing the receiver clock to the common network time; and
analyzing the status parameter to determine the synchronization status.

17. The method of claim 16, further comprising determining whether the status parameter indicates an acceptable synchronization status.

18. The method of claim 17, wherein the message further comprises RF data.

19. The method of claim 18, further comprising determining the usability of the RF data based on the determination of whether the status parameter indicates an acceptable status.

20. The method of claim 18, further comprising applying a weighing factor to the RF data based on the analysis of the status parameter.
